(19) United States
(12) Patent Application Publication
(10) Pub. No.: US 2014/0040081 A1
(43) Pub. Date: Feb. 6, 2014

(54) DETERMINING AN ESTIMATED QUANTITY OF A CONSTITUENT COMPONENT

(71) Applicants: Manish Marwah, Palo Alto, CA (US); Chandrakant Patel, Fremont, CA (US); Amip J. Shah, Santa Clara, CA (US)

(72) Inventors: Manish Marwah, Palo Alto, CA (US); Chandrakant Patel, Fremont, CA (US); Amip J. Shah, Santa Clara, CA (US)

(21) Appl. No.: 13/562,389

(22) Filed: Jul. 31, 2012

(51) Int. Cl. G06Q 10/08

(52) U.S. Cl. 705/29

(57) ABSTRACT

An identification of a constituent component is received. In response to receiving the identification, an estimated quantity of the constituent component in a product mix is determined, where the determining is based on bills of materials for corresponding product assemblies, and a data structure that stores information containing at least one metric for each of a plurality of components, the at least one metric indicating an impact of the corresponding component on an environment.

### BACKGROUND

Various constituent components can be used in a given product. For example, a computer can include a processor, a memory, a circuit board, a persistent storage device, and so forth. Each of the components of the computer can further be made up of sub-components, all the way down to the raw materials used to form the lowest-level sub-components.

### BRIEF DESCRIPTION OF THE DRAWINGS

Some embodiments are described with respect to the following figures:

FIG. 1 is a flow diagram of a process of estimating a quantity of a constituent component in a given product mix, in accordance with some implementations;

FIG. 2 is a flow diagram of another process for estimating a quantity of the constituent component, in accordance with further implementations;

FIG. 3 is a graph illustrating cost impact of different product mixes that include a particular constituent component, derived using techniques according to some implementations; and

FIG. 4 is a block diagram system incorporating some implementations.

### DETAILED DESCRIPTION

A constituent component, such as a raw material or other type of constituent component, can be present in various products that are offered by or used by an enterprise (e.g. business concern, government agency, educational organization, individual, etc.). A raw material can refer to a basic material from which a product assembly is manufactured. Examples of raw materials include steel, plastic, tantalum, a rare earth material, and so forth. A product assembly can refer to either a finished product (e.g. computer), or an assembly within the finished product (e.g. a hard disk drive in the computer). Generally, a “constituent component” refers to any component that makes up a portion of a finished product. In the ensuing discussion, reference to “product” is intended to refer to a finished product that is offered or used by an enterprise, while a product assembly can refer to any portion (or the entirety) of the product. Even more generally, a “component” can refer to any individual piece (e.g. a raw material, a sheet metal, etc.) or any combination of pieces. A product assembly can be made up of multiple components.

An enterprise that offers or uses a portfolio of products may not be aware of the specific amount of a particular constituent component in the product portfolio. In some examples, the supply chain of a given product can have a number of suppliers that provide various product assemblies that are assembled together to form a product. The suppliers may not provide detailed information regarding constituent components that are present in the corresponding product assemblies provided by the vendors. As an example, tantalum is a metal that is used in various electronic products, such as computers, mobile phones, display devices, and so forth. It may be difficult for an enterprise that sells the foregoing products to estimate a quantity of tantalum that the enterprise uses in its product portfolio. Thus, it may be difficult for the enterprise to predict an impact of variations in cost or variations in supply of tantalum.

In accordance with some implementations, techniques or mechanisms are provided to allow for the estimation of the quantity of a constituent component in a given product mix. A “quantity” can refer to a number of units, a weight, a volume, or any other measure of an amount of the constituent component. A “product mix” refers to any collection of products that may be offered or used by an enterprise. The product mix can be the entirety of the product portfolio offered or used by the enterprise, or alternatively, the product mix can include a subset of the product portfolio of the enterprise.

In some implementations, the estimation of a quantity of a constituent component in a given product mix can be based on the following sources of information: a bill of materials corresponding to each pertinent product assembly in the product mix; and an environmental impact database that contains information that includes at least one metric for each of multiple components, where the at least one metric indicates an impact of the corresponding component on an environment. The metric indicating impact of a corresponding component on an environment can refer to a metric that indicates an impact of the component on the ecological environment, an impact of the component on an enterprise (such as on the financial or sales activity of the enterprise, where the enterprise in this case is considered the “environment”), an impact on customers of the enterprise (where the collection of customers would be considered the “environment”), or any other type of impact that can be measured or estimated. Such metric can also be referred to as an “impact factor.”

Although reference is made to an environmental impact database, it is noted that in other examples, an environmental impact data structure according to another format can be used.

A bill of materials refers to any record (or combination of records) that contain(s) information relating to components of a product. The bill of materials can identify the assemblies and components that are part of the product. Different products may be associated with corresponding bills of materials. Although reference is made to a bill of materials associated with a product, it is noted that a bill of materials can also exist for a product assembly that is part of a product (e.g. the bill of materials for a product assembly, such as a hard disk drive, may have been provided by a supplier to a computer manufacturer that manufactures computers).

A bill of materials can be hierarchical in nature, with the top level representing a product. The next lower level of the hierarchy of the bill of materials can identify product assemblies that make up the product, and further lower levels of the hierarchy can identify components at various assembly levels. For example, a bill of materials can be for a computer, which has the following product assemblies: main circuit board, hard disk drive, chassis, and so forth. Each of the product assemblies may in turn have sub-assemblies. For example, the main circuit board can have a processor, a memory device, and so forth, while the hard disk drive may include a circuit board, a controller, a rotational storage medium, and so forth. The sub-assemblies can in turn be made up of further components.

In more specific examples, the environmental impact database can correlate various components to ecological environmental impacts, such as carbon footprint impact (e.g. a measure of carbon emissions associated with a given component), energy usage impact (e.g. a measure of usage of energy associated with a given component), water usage impact (e.g. a measure of usage of water associated with a given component), toxicity impact (e.g. a measure of a toxicity associated with a given component), and so forth.

In some examples, the environmental impact database can be arranged as a matrix of rows and columns. The different rows can correspond to different components (which can be part of various products), while the different columns can correspond to different metrics, including any of metrics listed above. For example, one of the rows of the matrix can correspond to a hard disk drive. One of the columns of the matrix can correspond to a carbon footprint metric. The intersection of the row corresponding to the hard disk drive and the column corresponding to the carbon footprint metric contains information relating to the carbon footprint associated with the hard disk drive. Another row of the matrix can include a raw material such as a rare earth material. The intersection of the row corresponding to rare earth material and the column corresponding to the carbon footprint metric contains information relating to the carbon footprint associated with the rare earth material.

In different examples, columns of the matrix can correspond to components, whereas rows of the matrix can correspond to metrics. Also, instead of a two-dimensional matrix, an environmental impact database can be a matrix having more than two dimensions. In other examples, instead of using a matrix, the environmental impact data structure can have other formats.

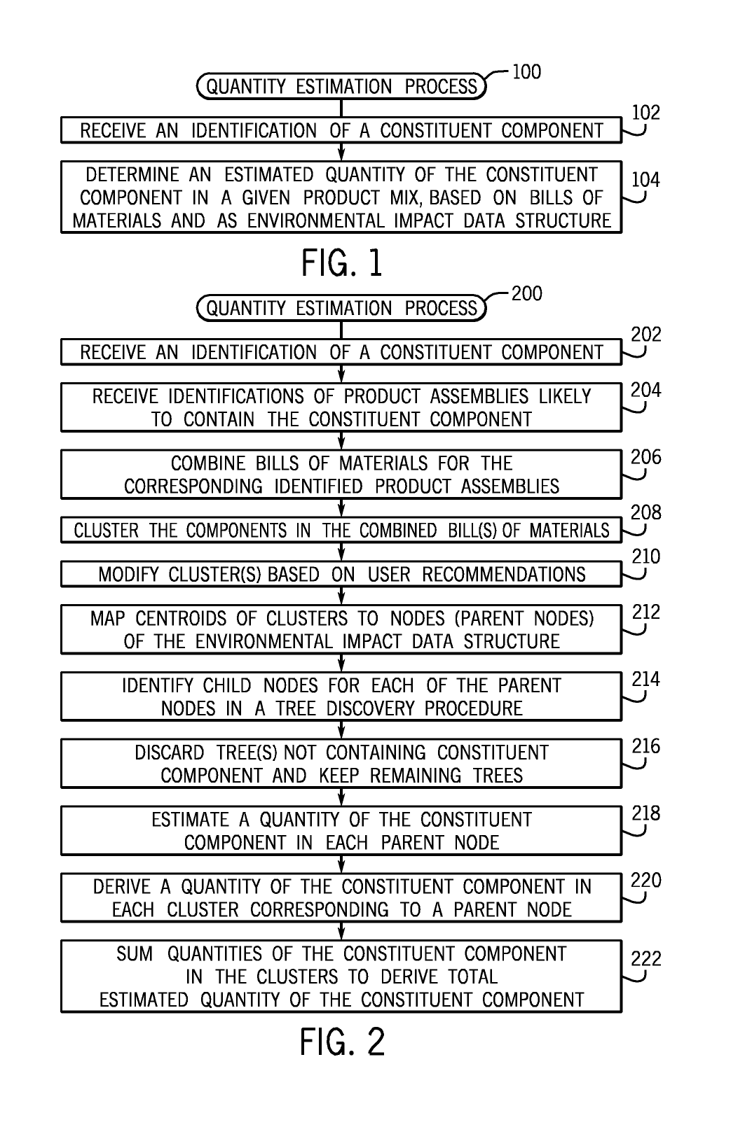

FIG. 1 is a flow diagram of a quantity estimation process 100 for estimating a quantity of a constituent component in a given product mix, in accordance with some implementations. The process 100 receives (at 102) an identification of the constituent component. This identification can be received from a user that is interested in estimating the quantity of the constituent component across the given product mix. Although reference is made to receiving an identification of a constituent component, it is also possible that the process 100 receives identifications of multiple constituent components for which quantity estimation is to be performed.

The process 100 next determines (at 104) an estimated quantity of the constituent component in the given product mix, in response to receiving the identification. The determining (at 104) is based on bills of materials for corresponding product assemblies that are indicated as potentially containing the identified constituent component. For example, for the given product mix, indications may have been provided (by a user or other entity) that certain product assemblies (e.g. motors, fans, disk drives, etc.) are likely to contain the identified constituent component. If bills of materials for these product assemblies exist, then they can be used for purposes of estimating the quantity of the constituent component in the given product mix. If a bill of materials for a product assembly (e.g. fan) does not exist, then a portion or all of the bill of materials for a higher-level product assembly (e.g. computer) in the product mix that contains the fan may be used. Thus, a bill of materials for a “corresponding” product assembly can refer to either the bill of materials that is created for the product assembly, or a bill of materials created for a higher-level assembly or product that contains the product assembly.

The determining (at 104) is further based on an environmental impact data structure that stores information containing at least one metric for each of multiple components, where the at least one metric indicates an impact of the corresponding component on an environment.

In examples where the process 100 received identifications of multiple constituent components for which quantity estimation is requested, the process 100 can determine estimated quantities for each of the identified constituent components, based on respective bills of materials and the environmental impact data structure.

The estimated quantity of a constituent component can be used for various purposes. For example, the estimated quantity of the constituent component can be used to predict an impact of variations in costs or supply of the constituent component. This can be used for planning purposes, or can be used to decide whether another constituent component can be selected to substitute a given constituent component. In other examples, what-if analysis can be performed, where different estimated quantities of a constituent component for different product mixes can be determined and compared.

FIG. 2 is a flow diagram of a quantity estimation process 200 according to further implementations. The process 200 receives (at 202) an identification of a constituent component (or identifications of constituent components) for which the quantity estimation process 200 is to be performed.

The process 200 further receives (at 204) identifications of product assemblies that are likely to contain the identified constituent component. For example, the user can specify that display devices, hard disk drives, and so forth are likely to contain the identified constituent component. Note that the user does not have to be 100% accurate. Inversely, the user can identify product assemblies that are unlikely to contain the identified constituent component, in which case the identifications of product assemblies received (at 204) are those product assemblies that are other than those identified as unlikely to contain the identified constituent component. As another example, a user may also choose to not specify any product assemblies, in which case the bills of materials of the entire product mix can be used.

The process 200 next combines (at 206) the bills of materials for the corresponding product assemblies identified (at 204). Combining the bills of materials for the identified product assemblies can refer to extracting the content of each of the bills of materials and inserting the extracted content into an integrated bill of materials. Alternatively, combining the bills of materials can refer to collecting and storing the bills of materials in a storage location that allows for relative ease of access.

The process 200 next clusters (at 208) the components in the combined bill(s) of materials using any of various cluster analysis techniques, such as K-means clustering, hierarchical agglomerative clustering, or any other type of clustering technique. The clustering (at 208) produces clusters (or groups) of nodes, where a node represents a corresponding component. Each cluster of nodes represents those components determined to be similar to each other by some clustering criterion, such as conceptual distance between the components (e.g. an ATA or AT Attachment hard disk drive can be considered to be similar to an SAS or Serial Attached SCSI hard disk drive; a flash memory device can be considered to be similar to a dynamic random access memory; and so forth). A distance metric is used to compare nodes that represent the components in the bill(s) of material, and nodes are clustered according to the distance metric. Each of the clusters can be associated with a respective centroid.

The clustering performed (at 208) can be seeded with product assemblies identified (at 204). Seeding a cluster refers to initializing a cluster to contain a particular item, in this case a product assembly identified (at 204). For example, if the identified product assemblies include a fan, motor, hard disk drive, and display device, then respective clusters can be initially created that include the fan, motor, hard disk drive, and display device, respectively. The clustering (at 208) can refine these clusters, and can form finer clusters of lower-level components.

In some implementations, to ensure that the clusters identified by the clustering (at 208) are of relatively high quality (according to a predefined criterion), cluster goodness statistics (measured, for example, by sum of square distances, silhouette coefficients, etc.) can be computed and reviewed by an expert or other user. The expert or other user can then recommend modifications to the clusters in appropriate cases, such as recommending splitting a cluster into multiple sub-clusters, or combining clusters into a larger cluster.

The user recommendations can also refine (modify) the distance metric used for comparing the nodes. For a further validation of the clusters, an expert or other user can be shown the most disparate nodes in each cluster to make sure such disparate nodes are within an acceptable error (in other words, the nodes are reasonably represented by the centroid of the cluster).

Based on user recommendations, the process 200 can modify (at 210) at least one of the clusters.

The process 200 maps (at 212) the centroids of the clusters to corresponding nodes in the environmental impact data structure discussed above. The mapping can be accomplished by comparing a component corresponding to the centroid of each cluster to the components of the environmental impact data structure, and selecting the component in the environmental impact data structure that most closely resembles the component corresponding to the centroid of the cluster.

Each of the nodes of the environmental impact data structure that are mapped from the centroids can be referred to as parent nodes. For each of the parent nodes, the process 200 identifies (at 214) corresponding child nodes (that are related to the parent node) using a tree discovery procedure. In addition, coefficients can be computed for each of the child nodes, where a coefficient can represent a quantity of a component represented by the child node. The tree discovery procedure involves finding the child nodes of a given parent node such that the sum (or other aggregate) of measures (also referred to as impact factors) relating to impact of the child nodes substantially matches a measure of impact of the parent node. “Substantially matching” refers to matching to within a predefined threshold or range of accuracy. Although reference is made to a tree that has a parent node and related child nodes, it is noted that in other implementations, groups of nodes can be discovered, where each group of nodes includes a parent node and related child nodes.

The tree discovery procedure effectively identifies the sub-parts (represented by the child nodes) that are part of the product assembly represented by the parent node. Specifically, the total impact (referred to as /) of a product assembly (represented by a parent node) is equal to the sum (or other aggregate) of impact factors for n (n≧2) components (represented by the child nodes) weighted by the appropriate coefficients:

I=w₁·I₁+w₂·I₂+ . . . +wₙ·Iₙ,

where wᵢ represents respective coefficients, and represents the impact factor(s) of each component, for i=1, . . . , n.

Note that I and Iᵢ are vectors and each includes m impact factor(s), where m≧1. The challenge is to search for the n correct nodes from the environmental impact database corresponding to the parent and then determine the coefficients {wᵢ, w₂, . . . , wₙ} that would result in the closest match of the known total impact I of the parent node. Successfully solving this would allow both the child nodes and the coefficients to be identified. In some examples, a technique based on use of the non-negative least squares (NNLS) technique to test how well certain subsets of nodes fit. In other examples, instead of NNLS, determining the optimal coefficients can be formulated as a constrained minimization problem. Since a brute force exploration of the entire space of subsets (in other words, examining all possible combinations of nodes in the environmental impact database to find the child nodes) is intractable, techniques according to some examples selectively sample what are referred to as “generators.”

A generator is a subset of nodes such that the generator contains a minimal number of nodes that satisfies a minimum threshold error criterion when supplied to NNLS, so if any node is removed from this subset it will no longer satisfy the threshold error criterion. The tree discovery procedure fixes a particular node and then samples a fixed number of generators that contain the particular node. This process is repeated for all nodes. These generators provide an idea of whether or not a particular node occurs concurrently with other nodes. If these generator samples for each node are referred to as “profiles,” then the next stage of the tree discovery procedure clusters similar profiles together. For instance, if node A occurs frequently with nodes B, C, and D, and if node B occurs frequently with nodes A, C, and D, then the profiles of A and B will belong in the same cluster because they are similar. In essence, nodes within a cluster can be considered to provide similar information. Next, the tree discovery procedure attempts to prune nodes from clusters to greedily increase the quality of the fit of the remaining subset of nodes, after which the process is left with the final tree.

It is noted that in other examples, other techniques for performing tree discovery can be utilized.

Each parent node and its respective subset of child nodes form a tree. The process 200 next discards (216) at least one tree that does not contain the constituent component as one of the child nodes in the tree. The process 200 keeps the remaining trees (these remaining trees are referred to as the “identified trees” in the ensuing discussion). Reducing the number of trees that have to be considered can reduce computational load, since a smaller amount of information has to be processed.

The process 200 then estimates (at 218) a quantity of the constituent component in the parent node (and more specifically, the quantity of the constituent component in the assembly represented by the parent node) of each of the remaining identified trees. Note that each parent node represents a product assembly that contains various components, as represented by child nodes in the tree corresponding to the parent node. One of the child nodes in the tree corresponds to the constituent component of interest. A quantity of the parent node is specified in the environmental impact data structure, where the quantity can be a weight or volume or other quantity of the assembly represented by the parent node. For example, the quantity of the assembly represented by the parent node can be a weight. Given this weight of the parent node, the quantity of the constituent component of interest can be derived, such as based on an understanding of what proportion of the assembly the constituent component makes up.

Note that the parent nodes of the identified trees (identified at 216) correspond to centroids of the clusters that were generated from the bills of materials at 208. Since a quantity of the constituent component of interest has been estimated at 218 for each parent node, this quantity can be used to derive (at 220) the quantity of the constituent component in the cluster having the centroid corresponding to each parent node. The cardinality of each cluster generated at 208 is known, where the cardinality of a cluster refers to the number of members of the cluster. If it can be assumed that each member of the cluster has generally the same quantity of the constituent component, then the quantity estimated for the corresponding parent node can be multiplied by the cardinality to estimate the quantity of the constituent component for the cluster.

More specifically, assume that a given parent node of an identified tree (identified at 216) is estimated (at 218) to have a quantity Q1 of the constituent component. This given parent node corresponds to cluster CA that was generated by the clustering at 208. The cluster CA has a cardinality N, where N refers to the number of members of the cluster CA. Then the estimated quantity of the constituent component in cluster CA derived (at 220) is equal to Q1*N, in some examples.

The process 200 next sums (at 222) the quantities of the constituent component in all of the clusters, to provide a total estimated quantity of the constituent component in the product mix under consideration. In other examples, instead of performing a simple sum of the quantities, a weighted sum can be applied, where each cluster can be assigned a respective weight coefficient.

It is noted that the quantity estimation of a constituent component can be re-run for different product mixes to perform what-if analysis. Based on the estimated quantities of the constituent component, an enterprise can select one of the product mixes to offer or use to meet specific particular goals, such as to reduce reliance on the constituent component.

The process 200 can also be re-run for different constituent components.

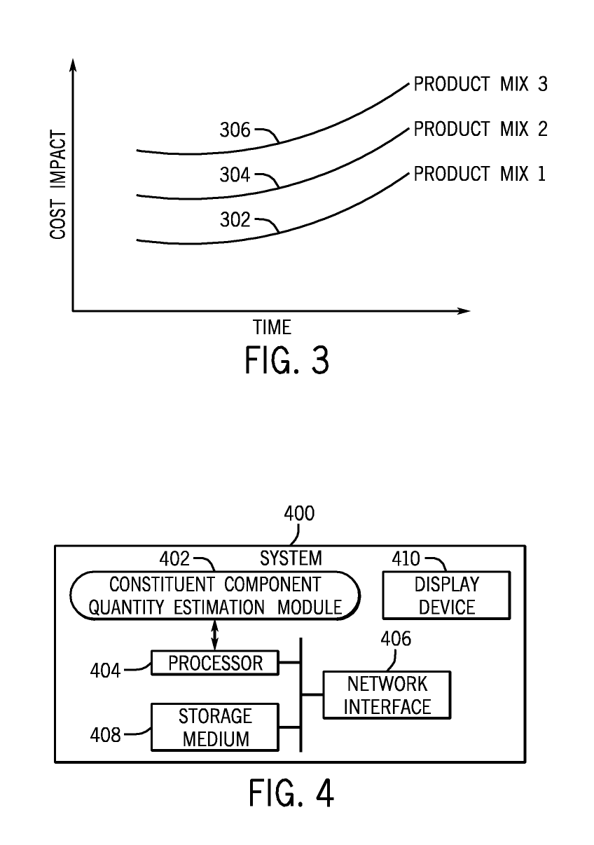

FIG. 3 is a graph illustrating curves 302, 304, and 306 for three different product mixes. The graph correlates time (horizontal axis) to the cost impact (vertical axis) due to presence of a particular constituent component (or constituent components) in a product mix. Each of the curves 302, 304, and 306 represents the cost impact of a corresponding product mix 1, 2, or 3. Each curve 302, 304, and 306 indicates that the cost impact of the particular constituent component(s) increases over time. However, it can be seen that the third product mix (associated with curve 304) has a larger overall cost impact as compared to the other two product mixes (represented by the curves 304 and 306, respectively).

The graph depicted in FIG. 3 is an example of an output that can be provided to a user to allow what-if analysis of cost impacts of different product mixes. Based on the graph, the user can select one of the product mixes as being more optimal than the other product mixes depicted in FIG. 3.

Using techniques or mechanisms according to some implementations, the effort of estimating the quantity of a particular constituent component in a product mix is reduced. Hot-spot analysis can be performed of products in terms of their usage of a particular constituent component. This allows an enterprise to quickly identify which of their products would be impacted by a particular constituent component. For example, if a government regulation specifies that enterprises are to perform diligence on their use of a particular raw material, starting at a particular time, then the enterprise can quickly perform hot-spot analysis to determine which of their products include the impacted raw material.

In addition, by being able to easily estimate quantities of a constituent component in products, an enterprise can use techniques or mechanisms according to some implementations to evaluate usage of the constituent component in the enterprise's supply chain.

FIG. 4 depicts a system 400 that includes constituent component quantity estimation module 402, which can be implemented as machine-readable instructions. The constituent component quantity estimation module 402 can perform various tasks discussed above, such as those in FIG. 1 or 2. The constituent component quantity estimation module 402 can be loaded for execution on a processor or processors 404. A processor can include a microprocessor, microcontroller, processor module or subsystem, programmable integrated circuit, programmable gate array, or another control or computing device.

The processor(s) 404 can be coupled to a network interface 406 (to allow the system 400 to perform communications over a data network) and a storage medium (or storage media) 408. The system 400 also includes a display device 410, which can be used to display outputs produced by the constituent component quantity estimation module 402, such as the graph shown in FIG. 3.

The storage medium or storage media 408 can be implemented as one or multiple computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

1. (canceled)

2. The method of claim 4, wherein metrics in the data structure allow a determination of a subset of the components whose aggregate impact substantially matches an impact of another component.

3. The method of claim 2, wherein the another component is a parent component, and the subset of components are child components of the parent component, and wherein one of the child components corresponds to the constituent component.

4. A method comprising:
receiving, by a system having a processor, identification of a constituent component;
determining, by the system in response to receiving the identification an estimated quantity of the constituent component in a given product mix, where the determining is based on bills of materials for corresponding product assemblies that are indicated as potentially containing the constituent component, and a data structure that stores information containing at least one metric for each of a plurality of components, the at least one metric indicating an impact of the corresponding component on an environment;
clustering the components in the bills of materials into clusters of the components; and
mapping the clusters to respective nodes of the data structure.

5. The method of claim 4, wherein the mapping comprises mapping centroids of the clusters to the respective nodes of the data structure.

6. The method of claim 4, wherein the nodes are parent nodes, the method further comprising:
finding child nodes of the parent nodes in the data structure, wherein each of the parent nodes in combination with a corresponding subset of the child nodes forms a respective tree.

7. The method of claim 6, wherein determining the estimated quantity is based on information in the trees.

8. The method of claim 7, further comprising:
disregarding at least one of the trees, the at least one tree containing no child node that corresponds to the constituent component,
wherein determining the estimated quantity is based on the information in the trees other than the disregarded at least one tree, where each of the trees other than the disregarded at least one tree includes a child node that corresponds to the constituent component.

9. A method comprising:
receiving, by a system having a processor, identification of a constituent component;
determining, by the system in response to receiving the identification an estimated quantity of the constituent component in a given product mix, where the determining is based on bills of materials for corresponding product assemblies that are indicated as potentially containing the constituent component, and a data structure that stores information containing at least one metric for each of a plurality of components, the at least one metric indicating an impact of the corresponding component on an environment;
determining a second estimated quantity of the constituent component in a second product mix, wherein determining the second estimated quantity is based on a second set of bills of materials and the data structure; and
comparing the estimated quantities of the constituent component in the corresponding product mixes.

10. The method of claim 1, wherein determining the estimated quantity of the constituent component comprises determining the estimated quantity of a raw material in the given product mix.

11. An article comprising at least one non-transitory machine-readable storage medium storing instructions that upon execution cause a system to:
receive an identification of a constituent component;
identify clusters of components based on information of bills of materials corresponding to product assemblies, wherein the clusters of components are identified using clustering according to a distance metric that represents similarity of the components;
map the clusters to nodes of a data structure that stores information containing metrics for corresponding components, the metrics indicating respective impacts of the corresponding components on an environment; and
estimate a quantity of the constituent component in a product mix, based on the mapped nodes of the data structure.

12. The article of claim 11, wherein the instructions upon execution cause the system to further:
receive identifications of the product assemblies in the product mix that are determined to likely contain the constituent component.

13. The article of claim 12, wherein the clustering uses the identified product assemblies to seed the clusters.

14. The article of claim 12, wherein receiving the identifications of the product assemblies is based on user identifications of product assemblies that are unlikely to contain the constituent component.

15. The article of claim 11, wherein the instructions upon execution cause the system to further:
combine the bills of materials, wherein identifying the clusters is based on the clustering applied on the combined bills of materials.

16. The article of claim 11, wherein the nodes of the data structure mapped to the clusters are parent nodes, and wherein the instructions upon execution cause the system to further:
identify child nodes of each of the parent nodes, wherein each of the parent nodes and the corresponding identified child nodes make up a respective group of nodes, wherein each of at least some of the groups of nodes has a child node corresponding to the constituent component,
wherein estimating the quantity of the constituent component is based on information relating to the at least some groups of nodes.

17. The article of claim 16, wherein the instructions upon execution cause the system to further:
estimate a quantity of the constituent component for each of the parent nodes of the at least some groups of nodes.

18. The article of claim 17, wherein the instructions upon execution cause the system to further:
use the estimated quantity for each parent node of the at least some groups of nodes to compute an estimated quantity of the constituent component for each of the clusters.

19. The article of claim 18, wherein the instructions upon execution cause the system to further:
aggregate the estimated quantities of the constituent component for the clusters to derive an overall estimated quantity of the constituent component in the product mix.

20. A system comprising:
at least one processor to:
receive identification of a constituent component;
determine, in response to receiving the identification, an estimated quantity of the constituent component in each of a plurality of product mixes, where the determining comprises:
clustering components in bills of materials for corresponding product assemblies that are indicated as potentially containing the constituent component, the clustering identifying clusters of components; and
mapping the clusters to nodes of a data structure that stores information containing at least one metric for each of a plurality of components, the at least one metric indicating an impact of the corresponding component on an environment; and
generate an output that depicts impact of presence of the constituent component in each of the product mixes.

21. The method of claim 4, wherein clustering the components in the bills of materials includes clustering using a distance metric that represents similarity of the components.

22. The article of claim 11, wherein the estimating comprises estimating the quantity of the constituent component in the product mix by using a quantity of the constituent component determined for each of the mapped nodes and a cardinality of the corresponding cluster.

23. The article of claim 22, wherein the cardinality of each of the clusters represents a number of members of the cluster.

24. The system of claim 20, wherein the determining further comprises:
estimating the quantity of the constituent component in each of the plurality of product mixes by using a quantity of the constituent component determined for each of the mapped nodes of the data structure and a cardinality of the corresponding cluster.
